(19) United States
(12) Patent Application Publication
(10) Pub. No.: US 2026/0322584 A1
(43) Pub. Date: Oct. 15, 2026

(54) Scheme for Programable and Testable Tie-values

(71) Applicant: Marvell Asia Pte Ltd, Singapore (SG)

(72) Inventor: Pushkar Anil Upadhye, Pune (IN)

(21) Appl. No.: 19/635,119

(22) Filed: Mar. 31, 2026

Related U.S. Application Data
(60) Provisional application No. 63/786,865, filed on Apr. 10, 2025.

(51) Int. Cl. H04L 9/06

(52) U.S. Cl. CPC H04L 9/06

(57) ABSTRACT

A method and system for programable and testable tie-values. Tie-values select and control the features and parameters of communication interfaces used by components of a computer chip or system. Tie-values are stored as data in registers, different data corresponding to the selection of different features and parameters of controlled communication interfaces. By changing the stored data, features and parameters of controlled communication interfaces can be updated or modified to satisfy changing needs and preferences. Programmable tie-values allow chip developers and users to adaptively control the operation and performance of a chip’s communication interfaces. A mirrored copy of the tie-values can be used to test the connectivity and implementation of the tie-values as well as to enable non-invasive software and hardware interactions.

### RELATED APPLICATION

This application claims the benefit of U.S. Provisional Application No. 63/786,865, filed on Apr. 10, 2025. The entire teachings of the above application is incorporated herein by reference.

### BACKGROUND

Computer systems, chips, and integrated circuits often include many components, blocks, or elements that communicate with each other utilizing communication interfaces. These communication interfaces are often complex and can support different speeds, feeds, use cases, line encodings, setting, and other features or parameters that relate to or are utilized by inter and intra chip and component communications. Often the utilized communication interfaces are configured to be usable in different computer systems and chips to facilitate communication between different components, blocks, and elements. While this allows the communication interfaces to be reused across a variety of computer systems and chips, different use cases require different features and parameters.

To support diverse uses, the features and parameters of communication interfaces are selected using tie-values. As non-limiting examples, setting a communication interfaces’ tie-values can be used to enable/disable select features, set signal speed, enable/disable feeds, set line encodings, set signal characteristics, and/or define other parameters of the communication interfaces. However, in traditional systems and methods, tie-values are constant and cannot be altered after or during chip development. Furthermore, there is a lack of ability to test the connectivity to the tie-values within a chip or its components which impedes and limits testing, debugging, and troubleshooting activity.

### SUMMARY

A need exists for the ability to update or modify tie-values to enable active and responsive control of their respective communication interfaces’ features and parameters. In particular, the tie-values should be configurable during chip design, fabrication, testing, as well as after tape-out when the chip design is finalized. A need also exists to observe, confirm, or test the tie-values’ connectivity with their controlled communication interfaces without interfering with components utilizing those communication interfaces or other ongoing chip activity.

Embodiments provide a solution to the existing limitations and needs in the art by enabling programmable, observable, and testable tie-values. These programmable tie-values can be modified during and after chip design and fabrication enabling greater control over their respective communication interfaces’ features and parameters. Furthermore, the tie-values can be programmed, observed, and tested using a separate or dedicated component which avoids intrusive actions on other chip components which could interrupt functions or delay design and fabrication.

An apparatus comprising at least one module, the module having at least one property and comprising a tie register configured to store a programable tie-value associated with each of the at least one property and wherein the at least one property is dependent on its respective programable tie-value.

The apparatus may further comprise an enable module, the enable module in communication with the tie register and configured to control the programable tie-value. In such embodiments, the programable tie-value may be binary value and the enable module may be a flip-flop.

The least one property can include one of the following, module speed, module input/outputs, module signal characteristics, module boot mode, module debug level, processing elements activation, or memory elements activation.

The apparatus may further comprise an observation register, the observation register in communication with the tie register and configured to store a copy of the programable tie-value and a read module configured to read the copy of the programable tie-value stored in the observation register and determine the at least one property of the module.

The apparatus may further comprise an encryption module, the encryption module configured to encrypt communications to and from the tie register. In such embodiments, the encryption module can comprise a XOR gate configured to implement an encryption mask.

The programable tie-value can be controlled based on software. The programable tie-value may have a default value and the at least one module can be configured to operate in a safe mode wherein the programable tie-value is set to the default value. The programable tie-value may be configured to be set, altered, or validated during development of the apparatus or the at least one module.

A method for programing and implementing tie-values, the method comprising:
storing a programable tie-value in a tie register, the programable tie-value corresponding to a property of a module and communicating the programable tie-value to the module and selecting a setting of the property of the module dependent on the programable tie-value.

The method may further comprise controlling the programable tie-value using an enable module. In such embodiments, the programable tie-value can be a binary value and the enable module can be a flip-flop.

The property may include one of the following, module speed, module input/outputs, module signal characteristics, module boot mode, module debug level, processing elements activation, or memory elements activation.

The method may further include storing a copy of the programable tie-value in an observation register, reading, by a read module, the copy of the programable tie-value stored in the observation register, and determining the property of the module based on the copy of the programable tie-value.

The method may also comprise encrypting communications to and from the register. The method can also include controlling the programable tie-value based on software output. The method may further comprise exiting a safe mode wherein the setting of the property of the module is set to a default value.

An apparatus for performing computing operations, the apparatus comprising means for storing a programable tie-value in a tie register, the programable tie-value corresponding to a property of a module and means for communicating the programable tie-value to the module and selecting a setting of the property of the module dependent on the programable tie-value.

The apparatus may further include means for storing a copy of the programable tie-value in an observation register, means for reading the copy of the programable tie-value stored in the observation register, and means for determining at the property of the module based on the copy of the programable tie-value.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram illustrating an example embodiment of a system for testable and programmable tie-values.

FIG. 2 is a flow diagram of an example method of utilizing testable and programmable tie-values.

FIG. 3 is a schematic view of a computer network in which embodiments may be implemented.

FIG. 4 is a block diagram illustrating an example embodiment of a computer node in the computer network of FIG. 3.

### DETAILED DESCRIPTION

A description of example embodiments follows.

The teachings of all patents, published applications and references cited herein are incorporated by reference in their entirety.

As used herein “chip,” “platform,” or “system” refers to a device configured to perform computing functions. This includes, but is not limited to, an integrated circuit or a set of integrated circuits. A chip may include interconnected circuit logic, sub-systems, or elements (also referred to herein as “components” or “modules”) that provide computing resources such as memory and compute utilized by the chip to perform computing tasks. As non-limited examples, these components include processors (CPUs, GPUs, cores, etc.), input/output interfaces (I/O interfaces), memory (RAM (Random Access Memory), ROM (Read-Only Memory) registers, caches, etc.), logic gates, busses, storage devices or interfaces for storage devices (HDD (Hard Disk Drive), SSD (Solid State Drive), etc.), or other computing hardware. A chip’s components may also include controllers or other more complex elements configured to perform or manage specific tasks including but not limited to, resource or task management, inter and intra chip or component communication, encryption, error detection or correction, and the like. Complex components may themselves be comprised of sets of simpler components and circuitry.

Data, signals, operations, tasks, and other communications are exchanged between chip components during operation. As a non-limiting example, a processing component may transmit a read/write operation to a memory component to access stored data. These commutations can be sent using any desired communication protocol or infrastructure that enable inter or intra chip or component communication. To manage communications, chips and/or their components utilize communications interfaces configured to send, receive, encode, encrypt, decode, or otherwise process incoming or outgoing data and signals. These communication interfaces may comprise of physical connectors such as but not limited to Peripheral Component Interconnect Express (PCIe) interfaces, Mobile Industry Processor Interfaces (MIPI), Serial Advanced Technology Attachment (SATA) interfaces, Inter-Integrated Circuit (I2C) interfaces, or other interfaces known in the art. Communication interfaces may be implemented as part of existing chip components or as standalone components. Communication interfaces may manage and enable commutations between any desired number of chip components and may comprise of hardware and/or software elements. Communication interfaces may implement or utilize desired commutation protocol to manage communications between chips and chip components.

Communication interfaces are often complex elements that support a variety of different speeds (e.g., the rate at which data is received or sent), feeds (e.g., where data is received or sent), and signal characteristics (e.g., the format of the received or sent data). Communication interfaces also can support a variety of different features such as but not limited to boot mode, debug level, processing elements, memory elements, and encryption. These different options for commutation interfaces are referred to herein as a commutation interface’s “features,” “parameters” or “properties.” This flexibility allows for a “generic” communication interface to support diverse use cases and line encodings that may be required by the variety of components comprising a chip or set of chips.

The same or similar communication interfaces can be used for or by multiple different components simplifying chip design and fabrication. However, even if different components use the same communication interface, they often require the implementation of different features or parameters of that communication interface. Communication interfaces utilize tie-values that control, enable, disable, or otherwise select their features and parameters. The number of tie-values can be equal to the number of selectable features and parameters, and different combinations of features and parameters are referred to as “flavors.” Tie-values may be implemented using hardware, software, or any other computing elements that enable the storage and selection of programable settings, information, or data. In some embodiments, tie-values comprise binary data stored in registers or equivalent memory devices. For each component, the tie-values of its respective communication interface can be selected so that it has the desired or required features and parameters for that component. As a non-limiting example, if a component needs a specific signal speed and format as well as to receive incoming signals through a desired feed, tie-values are selected to have the communication interface match those needs. This includes but is not limited to selecting or switching between PCIe Generation 6 or PCIe generation 5 support.

A chip and its components may be located on one or more boards, such as a printed circuit board or as an integrated circuit. Creating a chip includes the design, development, and fabrication of boards by adding or etching the components and their connections onto its surface. This may include configuring the features or parameters of the communication interfaces used for communication between a chip’s components. However, the requirements of a chip and a component may change during chip design and creation which can require an adjustment to the features or parameters of the communication interfaces. Furthermore, during chip design and creation, it is desirable for the components of a chip to be observed and tested which includes or relies upon knowledge of the selected and implemented features or parameters of their communication interfaces.

In prior art systems and methodologies, tie-values are constant or difficult to change. For example, they may be or depend on physical elements such as pins, fuses, or wires located on a chip that are manually set during chip fabrication. They also may be fully incorporated into chip components and difficult to access, modify or even observe both during and after chip design and fabrication. For example, some prior art systems and methodologies require a complete reset or even a physical change to the entire chip to alter a previously set tie-value. These prior art systems and methodologies limit or prevent entirely a chip’s creator and users from updating, expanding, testing, or otherwise controlling previously set tie-values and the communication interfaces’ features or parameters they determine.

Embodiments enable chip designs that include programable and configurable tie-values using registers. Alternative embodiments may use other storage elements capable of storing binary or non-binary data. Registers store data comprising tie-values that select a communication interface’s features or parameters. The stored tie-values can be programmed, modified, expanded, or updated using an enabler which in turn changes, adds, removes, or otherwise controls their respective communication interfaces’ features or parameters. As a non-limiting example, data comprising tie-values in the register may be modified using a write operation implemented by the enabler. Some embodiments include a default or safe mode where a desired combination of communication interface’s features or parameters are selected to be the flavor implemented on chip or component initiation and during default operation. Safe mode settings can correspond to binary data comprising “0s” stored in the tie-value’s registers.

The enabler may be part of the communication interface, part of the component that utilizes the commination interface, or located on a separate component. A shared enabler may control tie-values for multiple communication interfaces. In some embodiments, the enabler is implemented using hardware logic and is integrated into the chip’s management process and located on a bus connecting chip components. The enabler may also be implemented on a board or chip level using software or a combination of hardware and software.

A chip’s needs may change based on feedback after electrical characterization, to adapt to breaking specification updates, to enable board bring up work-arounds, in response to implementation of new use cases, or due to integration within a multi-chip system. Configurable and programable tie-values enabled by embodiments allow for new tie-value to be selected and corresponding communication interface flavors to be implemented that adapt to a chip’s changing needs. A designer, user, software program, chip component, or chip can access the enabler and use it to modify or configure the tie-values and subsequently control or change their respective communication interface’s features or parameters. This includes, but is not limited to, setting constant tie-values, modifying tie-values to adapt to a chip’s changing needs during development or use, entering safe mode, troubleshooting or testing chip, component, or communication interface features, updating commutation protocols, or modifying signal pathing, speed, or formatting. By using the enabler to control and configure tie-values, the communication interface’s features and parameters can be altered with zero or minimal interference with the chip and its components’ functions allowing for active and non-invasive development, testing, debugging, and troubleshooting. A user or developer may also even add new tie-values to the register to control additional communication interface features and parameters enabling a parameterization design that can easily scale the number of programmable tie-values and implementable flavors.

When tie-values are stored in a register or an equivalent memory element, to observe the selected flavor and determine the implemented combination of communication interfaces’ features and parameters one would expect that the register would need to be accessed, for example using a read operation. If the register is located on the communication interface, component, or other sensitive area of a chip, accessing it may be difficult or disruptive to ongoing development or use. Additionally, it is desirable to test and/or confirm that selected tie-values are actually communicating and implementing the intended parameters and features for their respective communication interfaces and chip components. Without a way to confirm tie-values and their implementation at the communication interface and chip component level it is often difficult to root cause or trace back identified problems. As a non-limiting example, if a component’s signal speed is abnormal, it could be difficult to determine if there is an issue with the hardware of that component or if the selected speed set by the tie-value has failed to be properly communicated and implemented.

Embodiments address and solve these issues by including a mirrored copy of the tie-values (also referred to as “actual tie-values” for distinction). This mirrored copy of the tie-values can be stored using a second registerer (“observation register”) or equivalent memory device on the enabler or at another accessible location. Some embodiments configure the observation register as read-only to allow observation but prevent tampering and to ensure fidelity with the actual tie-values. A snooping feature determines the settings of the actual tie-values and resulting flavor implemented at the controlled communication interface(s) and chip component(s) and updates the mirrored copy of the tie-values in the observation register to reflect the selected and implemented settings. If the mirrored copy of the tie-values is inconsistent with the actual tie-values it can indicate a failure of the selected flavor to be properly implemented. The mirrored copy of the tie-values also provides visibility of the tie-values to software, users, and developers without needing to access the storage location of the actual tie-values which may interfere with chip, component, or communication interface operation. The mirrored copy of the tie-values can be accessed using read/write operations, through other means including but not limited applications utilizing hardware or software.

Creating a separate and easily accessible source of information regarding the selected tie-values and implemented flavor is extremely useful during chip development and updating. If a chip or component is updated or changed, it can be difficult to determine how that update or change effects its operation as testing, observation, and troubleshooting abilities may be limited, unavailable, unproven, or inoperable. Embodiments solve this problem by maintaining or permitting legacy operation of the enable and the observation register storing the mirrored copy of the tie-values during or after implementation of new or modified operation of the controlled communication interface or chip component. For example, when updating the chip or its components to utilize new drivers, protocols, or other changes that may be unproven or unreliable, legacy or existing drivers or applications can be used to operate the enable and observe the mirrored copy of the tie-values and determine or test the actual tie-values and their implemented settings. This provides information regarding and the ability to test the effect of the new drivers, protocols, or other changes without requiring use of those unproven or unreliable changes and newly updated chip components.

Embodiment may also enable software to access and utilize the observation register and the mirrored copy of the tie-values and based on the information stored therein control, program, or otherwise modify the actual tie-values and their respective communication interface(s) and chip component(s). These software applications can observe and program tie-values and determine when certain features and parameters of the controlled communication features should implemented or modified. This can be in response to user input, detected outputs, triggered by the implementation of certain tasks or operations, in response to chip behavior, or other desired triggers, thresholds, inputs, or outputs. The implementation of tie-values programmed by software using an enabler component allows for greater control over the features and parameters of the communication interface without requiring the resetting or reconfiguration of chip components. This expands the ability of a chip’s designer, creator, and user to update or modify a chip’s settings, use cases, and applications. Software may also be used to select the tie-values that correspond to a default or safe mode operation and, if desired, update those selected tie-values in response to changing chip design or use. The software may further be configured to utilize legacy or prior drivers, protocols, or applications to test or observe the implementation of new drivers, protocols, or applications without being affected by unproven or untested modifications or updates.

Tie-values and the communication interface’s features and parameters they implement can include proprietary or confidential information of a chip’s designer and/or fabricator. To protect that information, some embodiments encrypt the mirrored copies of the tie-values stored in the observation register and communications comprising information about the actual and/or mirrored tie-values. This may include the application of an encryption mask from a chip’s security subsystem before, during, or after the communication of the actual tie-values to the enable component or other component hosting the observation register. It would be known to one skilled in the art that any desired method for encrypting inter or intra chip or component data, signals, or commutations can be used to protect both the transmission and storage of information related to tie-value and the selected flavors.

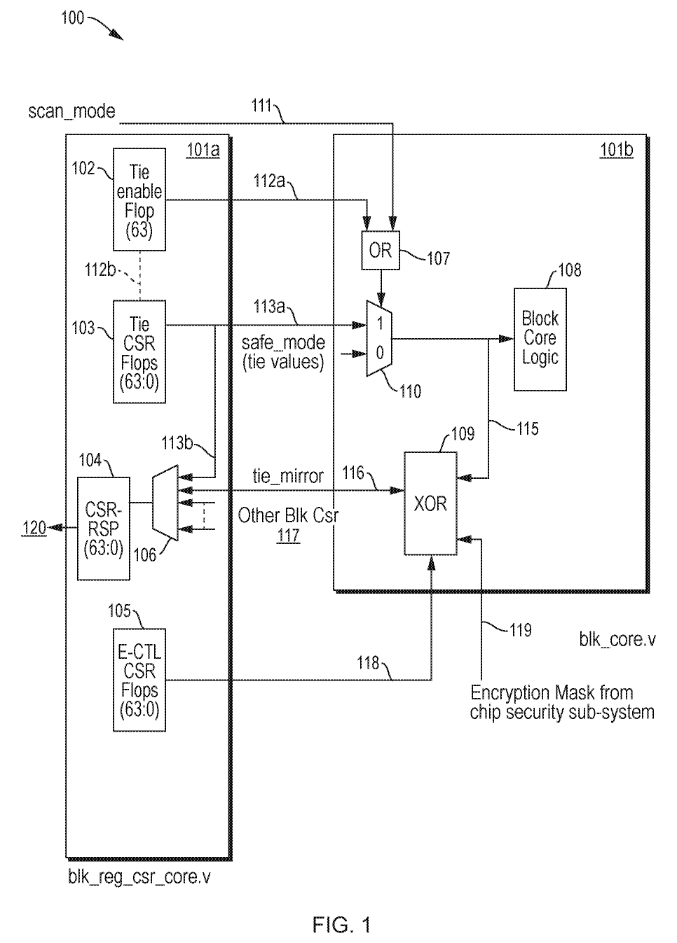

FIG. 1 is a block diagram illustrating an example embodiment of a system 100 for testable and programmable tie-values. System 100 may be a chip, circuit, or other collection of computing components. System 100 includes components, including but not limited to enabler 101a, core 101b, that exchange signals, data, and communications. System 100 utilizes its components to perform computing functions and operations. Core 101b includes block logic element 108 which is utilized by system 100 to perform operations. Block logic element 108 may include or be communicatively coupled with compute, I/O interface, memory, or other elements used by system 100 to perform operations. Block logic element 108 may include or utilize a communication interface that enables core 101b to send, receive, encode, decode, or otherwise process data, signals, or communications with other components of system 100.

The parameters and features of the communication interface used by core 101b are determined based on the tie-values stored in register 103. Register 103 can store tie-values as binary data and can comprise a series of flip/flop gates functioning as a control and status register (CSR). By communicating 113a, 114 the stored tie-values of register 103 to block logic element 108, the selected communication interface parameters and features are implemented. Communication 113a, 114 of tie-values can be sent on system 100 or core 101b boot, at desired intervals, in response to hardware or software outputs, in response to user input, or in response to other triggers or thresholds. By selecting, modifying, or changing the tie-values stored in register 103 the communication interface’s parameters and features used by core 101b can be programmed and controlled. Some embodiments include a safe mode where the tie-values of register 103 are set to predefined values (e.g., all “0s” in binary) which correspond to the initial or default settings features and parameters of component 101b. Safe mode tie-values may be preloaded constant values, alternatively some embodiments allow for the safe mode values to be altered by software, user input, or in response to other stimuli. A multiplexer 110 can be used to initiate or exit safe mode in response to an input 111 received from components of system 100.

Embodiments also include enable 101a. Enable 101a is used to modify and program the tie-values in register 103 and therefore control the communication interface parameters and features used by core 101b. Enable 101a includes tie-enable 102 circuit logic configured to control or modify tie-values stored in register 103. In system 100, shown in FIG. 1, tie-enable 102 is a flip/flop gate. Tie-enable 102 is configured to issue or transmit an operation (e.g., a write command) 112b to register 103 to modify or program its stored tie-values. Tie-enable 102 can also issue a signal 112a to multiplexer 110 to activate or deactivate safe mode. This may be done using an OR gate 107 or other circuit logic elements. If safe mode is activated, multiplexer 110 communicates 114 set safe mode tie-values to block logic element 108. Alternatively, if safe mode is deactivated, multiplexer 110 communicates 114 the programable tie-values it receives 113a from register 103. Using multiplexer 110, tie-enable 102 can both implement default safe mode tie-values or implement programable tie-values stored in register 103. If needed, tie enable 102 may also be used to modify the number of tie-values stored in register 103, allowing for control over new features or parameters of the communication interface used by core 101b.

Enable 101a also includes observation register 104 which stores mirrored copies of the tie-values stored in register 103. Register 104 can store mirrored tie-values as binary data and can comprise a series of flip/flop gates serving as a control and status register (CSR). When stored tie-values are communicated 113a from register 103 to core 101b, they are also communicated 113b to observation register 104. In that way, the mirrored tie-values in observation register 104 match the tie-values in register 103 and can be used to provide indirect knowledge thereof. To further ensure fidelity between the tie-values and mirrored tie-values, communication 114 to block core logic 108 can include or trigger communication 115 which sends confirmation 116 of the tie-values implemented by block core logic 108 back to observation register 104. Communications 113b, 115, and 116 along with the mirrored tie-values stored in register 104 can be used to confirm or test the connectivity of the tie-values stored in register 103 with core 101b and block core logic 108.

In some embodiments, confirmation communications 116 can be encrypted to protect tie-value information and settings. In such embodiments, an encryption mask signal 119 can be received by core 101b and encryption mask signal 119 can be combined in an XOR gate 109 with encryption control information 118 stored in an encryption register 105 to encrypt and protect confirmation communications 116 between enable 101a and core 101b. It would be understood that the encryption method and elements utilized shown in FIG. 1 is a non-limiting example and equivalent encryption methods utilizing alternative elements or circuit logic may also be utilized by alternative embodiments.

Observation register 104 may also mirror additional tie-values utilized by core 101b or other components of system 101. Received signals 117 may be equivalent to communications 113b and 116 for such additional mirrored tie values. Observation register 104 may utilize multiplex 106 or other circuit elements to receive, select, or implement incoming communications or operations 113b, 116, and 117.

Finally, observation register 104 may communicate 120 its stored mirrored tie-values to other components of system 100. Communication 120 can include or be issued in response to a read operation accessing observation register 104. Communication 120 may also be issued in response to software or hardware outputs, user inputs, or other triggers or thresholds of system 100. Communication 120 provides information regarding the settings, features, and parameters of component 101b and block core logic 108 implemented using the programmable tie-values of register 103 without requiring direct access or observation. Communication 120 can be used for troubleshooting, debugging, and testing purposes during chip design, fabrication, and use. Communication 120 may be sent or generated using legacy divers, settings, or protocols while core 101b and block core logic 108 are utilizing new or updated divers, settings, or protocols.

System 100 shows one possible distribution of registers 103, 104, and 105 and circuit elements 102, 107, 110, 108, 109 between enable component 101a and core component 101b. Other embodiments may distribute registers 103, 104, and 105 and circuit elements 102, 107, 110, 108, 109 in any desired configuration between components of system 100 including but not limited to enable component 101a and core component 101b.

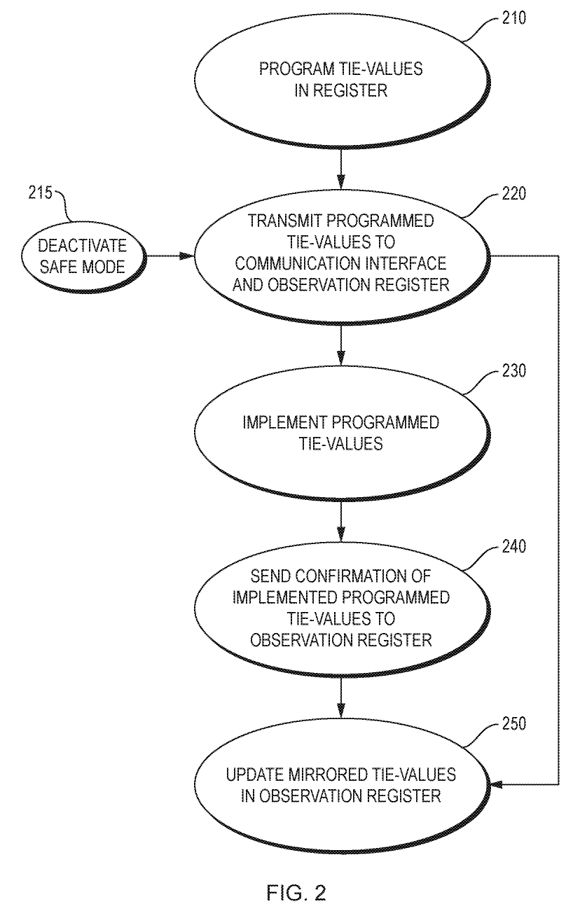

FIG. 2 is a flow diagram of an example method 200 of utilizing testable and programmable tie-values. Method 200 may be implanted during chip development, creation, fabrication, or use to update a chip’s settings and behavior in response to changing needs or use cases. For example, method 200 can be used to apply post electrical validation and characterization updates to the tie-values in the same generation of chips without having to re-spin or reset the chip. Method 200 may also be implemented as part of testing or troubleshooting actions for non-limiting example to test new settings, features, drivers, or other modifications made to a chip and/or its components. Method 200 may be implemented using standard communication interfaces and adapted for use in a variety of different chips, computer systems, and integrated circuits.

Method 200 begins with tie-values being selected or programmed 210 in a register. The programmed tie-values correspond to the desired parameters and features of a controlled communication interface for at least one chip component. The tie-values can be programmed using software, hardware, or user inputs. Programming the tie-values can comprise a write operation that modified the data stored in the register, different stored data corresponding to different selections of tie-values. A controller or other component may be used to initiate, send, and manage the operations required to program 210 the tie-values. Some embodiments may, as part of programming 210 the tie-values enable the addition of new tie-values to control additional features and parameters of the communication interface allowing for easy scalability.

Some embodiments optionally include the deactivation 215 of a safe mode, that changes the tie-value being communicated from a set default value to the tie-values programmed in step 210. The safe mode may be deactivated 215 in response to software instructions, hardware outputs, user input or other set thresholds or triggers. Subsequently, the programmed tie-values are communicated 220 to both the communication interface they control and an observation register. Communication 220 can be done using any method of intra or inter chip or component communications for example, through a main bus and/or with PCIe interfaces.

After the tie-values are communicated 220 to the controlled communication interface, the selected settings represented by the programed tie-values are implemented. This includes but is not limited to the setting of module speed, module input/outputs, module signal characteristics and the activation and deactivation of features such as module boot mode, module debug level, processing elements, memory elements, or module interfaces. The confirmation of the implemented programmed tie-values are also sent 240 to the observation register. Communication 240 may be sent in series or in parallel to the implementation 230 of the programmed tie-values. Communication 240 can be done using any method of intra or inter chip or component communications for example, through a main bus and/or with PCIe interfaces. In some embodiments communication 240 can be encrypted to protect propriety commutation interface settings, features, or parameters.

Finally, based on communications 220 and 240, mirrored tie-values stored in the observation register are updated 250 to match the programmed tie-values and the implemented tie-values. Updating 250 the mirrored tie-values can comprise a write operation that modified the data stored in the register, different stored data corresponding to different selections of tie-values. A controller or other component may be used to initiate, send, and manage the operations required to update 250 the mirrored tie-values. The mirrored tie-values resulting from method 200 can be used as an indirect source of knowledge of the programmed tie-values and settings of the controlled communication interface allowing users, developers, programs, or components to access and use that knowledge without interfering with the controlled communication interface’s operation. Similarly, the mirrored tie-values can be used to test, debug, or troubleshoot the implementation and/or connectivity of the programmed tie-values again without requiring direct access to and possible interference with the controlled communication interface. For example, mirrored tie-values can be used to test the connectivity and/or implementation of the programmed tie-values to and at the controlled communication interface in steps 220 and 230.

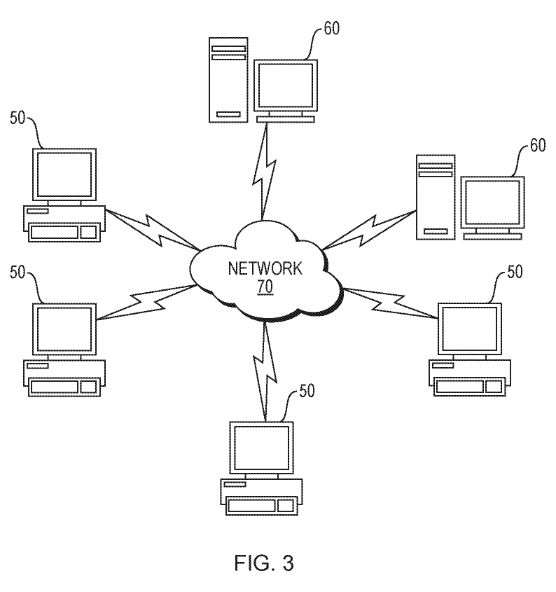

FIG. 3 is a schematic view of a computer network in which embodiments may be implemented. Client computer(s)/devices 50 and server computer(s) 60 provide processing, storage, and input/output (I/O) devices executing application programs and the like. Client computer(s)/devices 50 and server computer(s) 60 may comprise of or include integrated circuits, computer chips, and components disclosed herein and utilized by the disclosed embodiments. Client computer(s)/device(s) 50 can also be linked through communications network 70 to other computing devices, including other client device(s)/processor(s) 50 and server computer(s) 60. The communications network 70 can be part of a remote access network, a global network (e.g., the Internet), cloud computing servers or service, a worldwide collection of computers, local area or wide area networks, and gateways that currently use respective protocols (e.g., TCP/IP, Bluetooth®, etc.) to communicate with one another. Other electronic device/computer network architectures are also suitable. Network 70 can communicatively couple component nodes (client computer(s)/devices 50 and server computer(s) 60) that serve as accelerators that may include CPUs, GPUs or TPUs as non-limiting examples. Client computer(s)/devices 50 and server computer(s) 60 and other components may be interconnected by using a bus, PCIe interface, or other directly wired connections or interfaces.

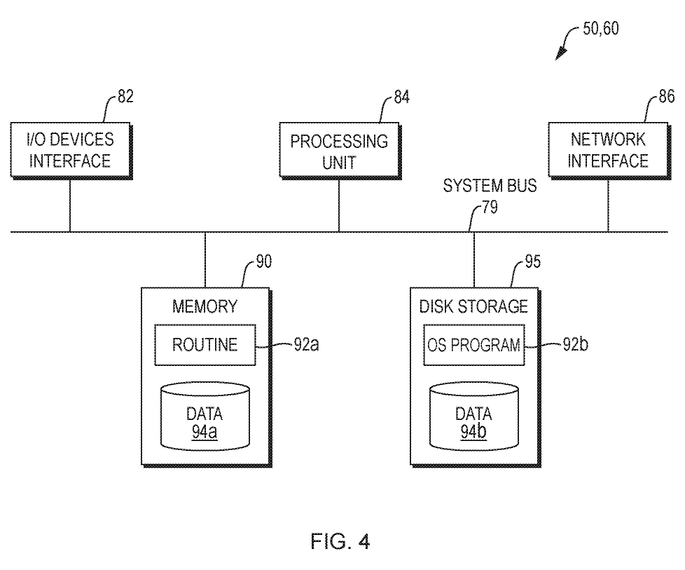

FIG. 4 is a block diagram illustrating an example embodiment of a computer node (e.g., client processor(s)/device(s) 50 or server computer(s) 60) in the computer network 70 of FIG. 3. Each computer node 50, 60 contains system bus 79, where a bus is a set of hardware lines used for data transfer among components of a computer or processing system. The system bus 79 is essentially a shared conduit that connects different elements or components of a computer system (e.g., processor, disk storage, memory, I/O ports, network ports, etc.) that enables transfer of information between the elements. Attached to the system bus 79 is an I/O devices interface 82 for connecting various input and output devices to the computer node 50, 60. A network interface 86 allows the computer node to connect to various other devices attached to a network (e.g., the network 70 of FIG. 3). A memory 90 provides volatile storage for computer software instructions 92a and data 94a used to implement embodiments of the present disclosure (e.g., the method 200 of FIG. 2, the applications used to program and test tie-values). A disk storage 95 provides non-volatile storage for the computer software instructions 92b and data 94b used to implement an embodiment of the present disclosure. A central processor unit (CPU) or other compute source 84 is also attached to the system bus 79 and provides for execution of computer instructions. Elements 82, 84, 86, 90, and 95 of computing device 50, 60 and/or their subcomponents may utilize communication interfaces whose features and parameters are controlled using programmable and testable tie-values according to disclosed embodiments such as but not limited to method 200. Computers 50, 60 may be used to control chip or integrated circuit design, fabrication, testing or use and utilize disclosed embodiments to program and/or test tie-values of the chips or integrated circuits.

In an embodiment, the processor routines 92a-92b and data 94a-94b are a computer program product (generally referenced as 92), including a non-transitory, computer readable medium that provides at least a portion of the software instructions used in the disclosure methods. The computer program product 92 can be installed by any suitable software installation procedure, as is well known in the art. In another embodiment, at least a portion of the software instructions may also be downloaded over a cable, communication, and/or wireless connection. In other embodiments, the disclosure programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present disclosure routines/program 92.

In alternative embodiments, the propagated signal is an analog carrier wave or digital signal carried on the propagated medium. For example, the propagated signal may be a digitized signal propagated over a global network (e.g., the Internet), a telecommunications network, or other networks (such as the network 70 of FIG. 3). In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of the computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium, and the like.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While example embodiments have been particularly shown and described, it will be understood by those skilled in the art that various changes in form and details may be made therein without departing from the scope of the embodiments encompassed by the appended claims.

What is claimed is:

1. An apparatus comprising:
at least one module, the module having at least one property and comprising a tie register configured to store a programable tie-value associated with each of the at least one property; and
wherein the at least one property is dependent on its respective programable tie-value.

2. The apparatus of claim 1 further comprising an enable module, the enable module in communication with the tie register and configured to control the programable tie-value.

3. The apparatus of claim 2 wherein the programable tie-value is a binary value and the enable module is a flip-flop.

4. The apparatus of claim 1 wherein the at least one property includes one of the following, module speed, module input/outputs, module signal characteristics, module boot mode, module debug level, processing elements activation, or memory elements activation.

5. The apparatus of claim 1 further comprising:
an observation register, the observation register in communication with the tie register and configured to store a copy of the programable tie-value; and
a read module configured to read the copy of the programable tie-value stored in the observation register and determine the at least one property of the module.

6. The apparatus of claim 1 further comprising an encryption module, the encryption module configured to encrypt communications to and from the tie register.

7. The apparatus of claim 6 wherein the encryption module comprises a XOR gate configured to implement an encryption mask.

8. The apparatus of claim 1 wherein the programable tie-value is controlled based on software.

9. The apparatus of claim 1 wherein the programable tie-value has a default value and the at least one module is configured to operate in a safe mode wherein the programable tie-value is set to the default value.

10. The apparatus of claim 1 wherein the programable tie-value is configured to be set, altered, or validated during development of the apparatus or the at least one module.

11. A method for programing and implementing tie-values, the method comprising:
storing a programable tie-value in a tie register, the programable tie-value corresponding to a property of a module; and
communicating the programable tie-value to the module and selecting a setting of the property of the module dependent on the programable tie-value.

12. The method of claim 11 further comprising controlling the programable tie-value using an enable module.

13. The method of claim 12 wherein the programable tie-value is a binary value and the enable module is a flip-flop.

14. The method of claim 11 wherein the property includes one of the following, module speed, module input/outputs, module signal characteristics, module boot mode, module debug level, processing elements activation, or memory elements activation.

15. The method of claim 11 further comprising
storing a copy of the programable tie-value in an observation register;
reading, by a read module, the copy of the programable tie-value stored in the observation register; and
determining the property of the module based on the copy of the programable tie-value.

16. The method of claim 11 further comprising encrypting communications to and from the register.

17. The method of claim 11 further comprising controlling the programable tie-value based on software output.

18. The method of claim 11 further comprising exiting a safe mode wherein the setting of the property of the module is set to a default value.

19. An apparatus for performing computing operations, the apparatus comprising:
means for storing a programable tie-value in a tie register, the programable tie-value corresponding to a property of a module; and
means for communicating the programable tie-value to the module and selecting a setting of the property of the module dependent on the programable tie-value.

20. The apparatus of claim 19 further comprising:
means for storing a copy of the programable tie-value in an observation register;
means for reading the copy of the programable tie-value stored in the observation register; and
means for determining at the property of the module based on the copy of the programable tie-value.
